(19) United States
(12) Patent Application Publication
(10) Pub. No.: US 2009/0214068 A1
(43) Pub. Date: Aug. 27, 2009

(54) TRANSDUCER ASSEMBLY

(75) Inventor: Timothy K. Wickstrom, Elk Grove Village, IL (US)

Correspondence Address: MARSHALL, GERSTEIN & BORUN LLP;(KNOWLES), 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 12/182,841

(22) Filed: Jul. 30, 2008

Related U.S. Application Data
(60) Provisional application No. 61/031,483, filed on Feb. 26, 2008.

(51) Int. Cl. H04R 11/04

(52) U.S. Cl. 381/358; 381/357

(57) ABSTRACT

A microphone includes a housing including a structure and a motor assembly. The housing includes an inner space and the motor assembly mounted in the housing divides the inner space into a front volume and a back volume. The structure formed as part of the housing includes a plurality of openings, e.g. notches in different dimensions. The openings may act as a time delay structure to modify the directivity characteristics of the microphone.

### CROSS-REFERENCE TO RELATED APPLICATIONS

This patent claims benefit under 35 U.S.C. §119(e) to U.S. Provisional Patent Application Ser. No. 61/031,483 filed Feb. 26, 2008, the disclosure of which is hereby expressly incorporated herein by reference.

### TECHNICAL FIELD

This patent generally relates to transducers and in particular to a directional microphone adapted to operate with a plurality of openings.

### BACKGROUND

One type of a directional transducer, e.g., microphone, for converting an acoustic signal into an electrical signal includes a cavity formed within a housing. A diaphragm within the housing divides the cavity into a back volume and a front volume. A front port communicates with the front volume, and a rear port communicates with the back volume. Placing an acoustic resistance, such as a screen, a channel, or a porous material, in the rear port creates a time-delay structure to modify the time it takes a sound signal arriving at the rear port to strike the diaphragm and hence modifies the directionality characteristics of the microphone. To create a second-time delay structure, the rear and front ports may be physically spaced apart so that a sound signal traveling through the front port and the front volume and also traveling through the rear port and the back volume strike the diaphragm at different times. However, if the microphone is built with both first and second time-delay structures, i.e, first time-delay structure in the rear port and the second time-delay structure in the front port, the internal time delay for the sound signal to travel through the rear port may equal to the internal time delay for the sound signal to travel through the front port. In this case, the sound signals strike the diaphragm simultaneously and the sound pressure is canceled and no electric signal is generated.

### BRIEF DESCRIPTION OF THE DRAWINGS

For a more complete understanding of the disclosure, reference should be made to the following detailed description and accompanying drawings wherein:

FIG. 1 is a perspective view illustrating a transducer assembly such as a directional microphone according to a described embodiment;

FIG. 2 is an exploded view of the transducer assembly of FIG. 1;

FIG. 3 is a cross-sectional view of the transducer assembly shown in FIG. 1;

FIG. 4 is a cross-sectional view of a structure for a transducer assembly such as a directional microphone in accordance with one or more of the described embodiments; and

FIG. 5 is a cross-sectional view of another exemplary structure for a transducer assembly such as a directional microphone in accordance with one or more of the described embodiments.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein

### DETAILED DESCRIPTION

While the subject matter of this patent is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims. Throughout the following detailed description, similar reference numbers refer to respective similar elements in all figures of the drawings.

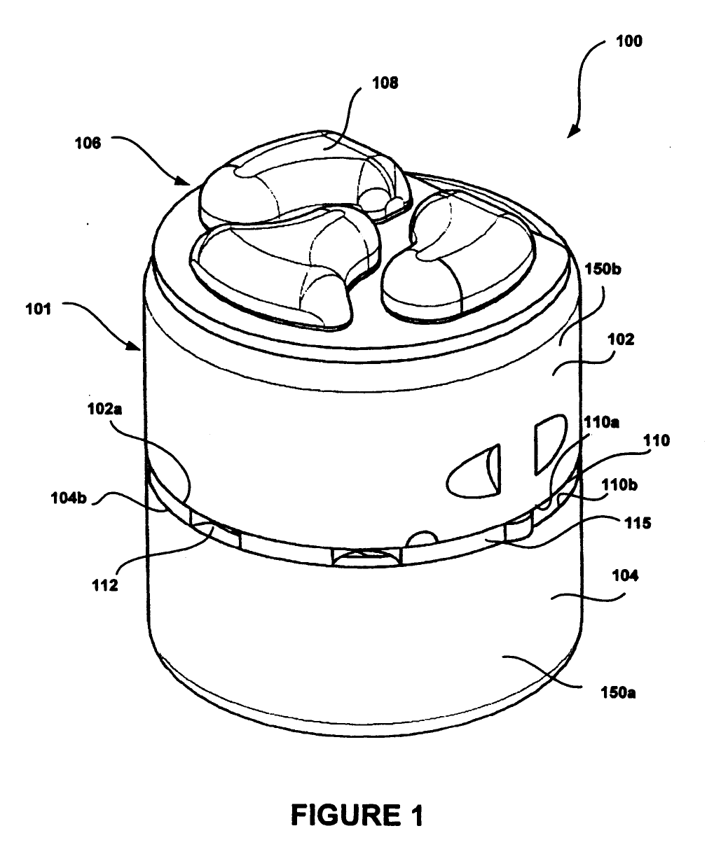

FIG. 1 illustrates a perspective view of a transducer 100 that can be used in virtually any type of electronic device, gaming device, communication device, camera, entertainment device, listening device (e.g. earphones, headphone, Bluetooth wireless headset, insert earphone, UWB wireless headset, hearing aid) and the like. When used in hearing aids, such devices may be a behind-the-ear (BTE), in-the-ear (ITE), in-the-canal (ITC), completely-in-the-canal (CIC), receiver-in-the ear (RIE), combined BTE/ITE, combined BTE/ITC, combined BTE/CIC, combined BTE/RIE, or the like type hearing aids. The foregoing list of listening devices is not exhaustive, and one will appreciate that other types of listening device are possible.

The transducer 100 may be a receiver, a speaker or a microphone. Two or more transducers 100 may be combined, and in combinations may be a combined receiver and microphone, combined multiple microphones or combined multiple receivers, depending on the desired applications. In the embodiment shown, the transducer 100 is a directional microphone. The transducer 100 may include a housing 101 including a top housing portion 102 and a bottom housing portion 104. Housing portions 102 and 104 each have an end wall 102a and 104a, respectively, at an opening end thereof. A disk or plate-like structure 110 is fixedly coupled to the housing portions 102 and 104 between the end walls 102a and 104a. The structure 110 may have the form of a substantially annular ring and may correspond to the configuration of the housing 101.

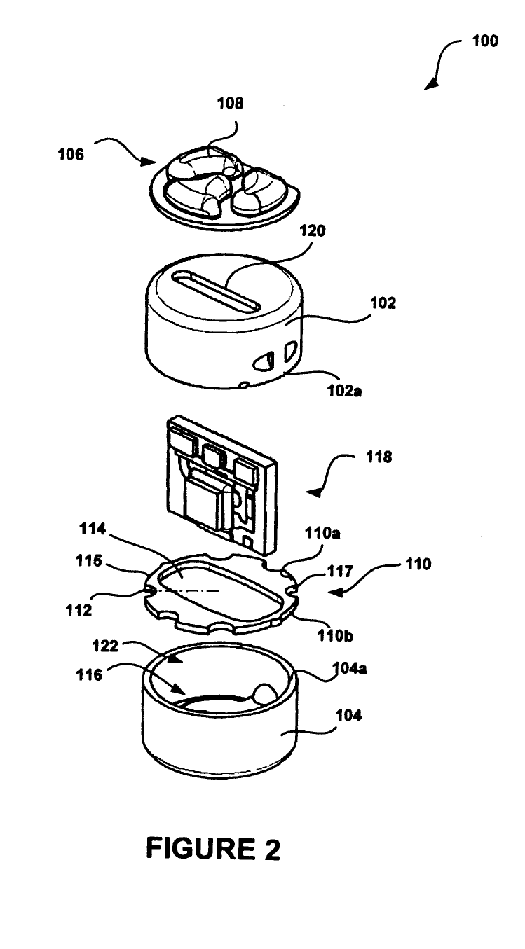

The structure 110 may include a first surface 110a, a second surface 110b, and a plurality of openings 112, e.g. notches formed in a peripheral edge 115 of the structure 110. The openings 112 allow acoustic signals, e.g., sounds to pass from above and below the structure 110. With the end walls 102a, 104b of the housings 102, 104 joined to the first and second surfaces 110a, 110b of the structure 110 adjacent to the openings 112 by any suitable technique to form a complete housing, the openings 112 existing along an inside surface 117 (as shown FIG. 2) of the housing 101 permit sounds outside the housing 101 to enter and interact with an inner space 122 (as shown in FIG. 2) formed by the housing 101 or to permit sounds generated within the housing to be transmitted outside the housing when the transducer 100 is configured as a receiver or a speaker. The housing portions 102, 104 and the structure 110 may be manufactured from a variety of materials such as, for example, stainless steel, plastic or composite materials including laminate structures that may have alternating layers of conductive and non-conductive materials, metal particle-coated plastics, or the like.

The transducer 100 further includes a flex circuit assembly 106 and at least one terminal pad 108, three are illustrated, electrically coupled to the flex circuit assembly 106 to permit connecting of the transducer 100 to an external device (not shown). The external device may be a printed circuit board (PCB), a transducer, a portion of an electronic device or an electronic device. The flex circuit assembly 106 may be attached to any surface of the housing 101 as long as the flex circuit assembly 106 does not block the openings 112. As shown, the flex circuit assembly 106 is attached to the top housing portion 102 but it may as easily be attached to the bottom housing portion 104.

FIG. 2 illustrates an exploded view of the transducer 100. The transducer 100 further includes a motor assembly 116 and a circuit assembly 118 disposed in the housing 101. An optional opening 120 may be formed on the top housing 102 to allow electrical connection from the flex circuit assembly 106 to the circuit assembly 118. An aperture 114 may be formed within the structure 110 to receive various working components of the transducer 100, e.g. the circuit assembly 118.

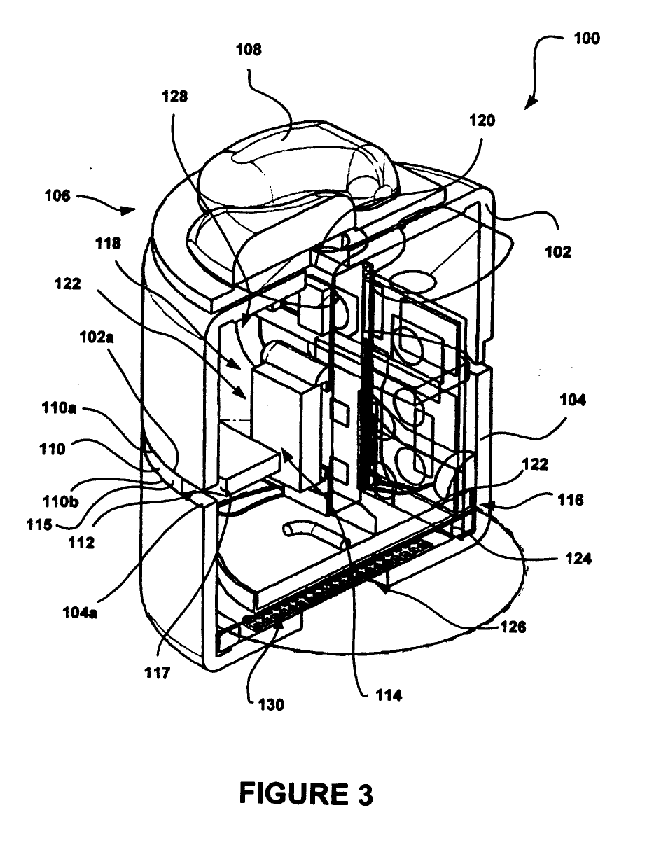

FIG. 3 illustrates a cross-sectional view of the transducer 100. The motor assembly 116 may be of typical construction and includes a backplate assembly 122 and a diaphragm assembly 124. It will be understood that the operation of the transducer 100 is generally based on the change in capacitance and resulting electrical signal that may be generated as a result of movement of the diaphragm assembly 124 responsive to the exposure to sound pressure relative to a fixed electrode on the backplate assembly 122. As shown, the motor assembly 116 is mounted within the bottom housing portion 104 of the transducer 100, and an opening 126 adjacent to the motor assembly 116 is formed in the bottom housing portion 104. The opening 126 permits acoustic energy, e.g., sound from the surrounding outside of the housing 101 to enter the housing 101, and the diaphragm assembly 124 senses the sound from the opening 126. The circuit assembly 118, mounted within the housing 101, is electrically coupled to the motor assembly 116 by any known techniques. Once the motor assembly 116 is disposed in the housing 101, the inner space 122 is divided by the motor assembly 116 into a front volume 130 and a back volume 128, and the circuit assembly 118, behind the motor assembly 116, is positioned in the back volume 128, and the opening 126, in front the motor assembly 116, interacts with the motor assembly 116 via the front volume 130. The structure 110, provided with a plurality of openings 112, is located and placed over the motor assembly 116 so as to couple the back volume 128 to the surroundings outside of the housing 101 via the openings 112. The openings 112 that couple the back volume 128, behind the motor assembly 116, form a time delay structure for sound entering these openings 112. It will be noted that the transducer 100 with various first-order directional patterns may be selected by changing the dimensions of the openings 126 of the structure 110.

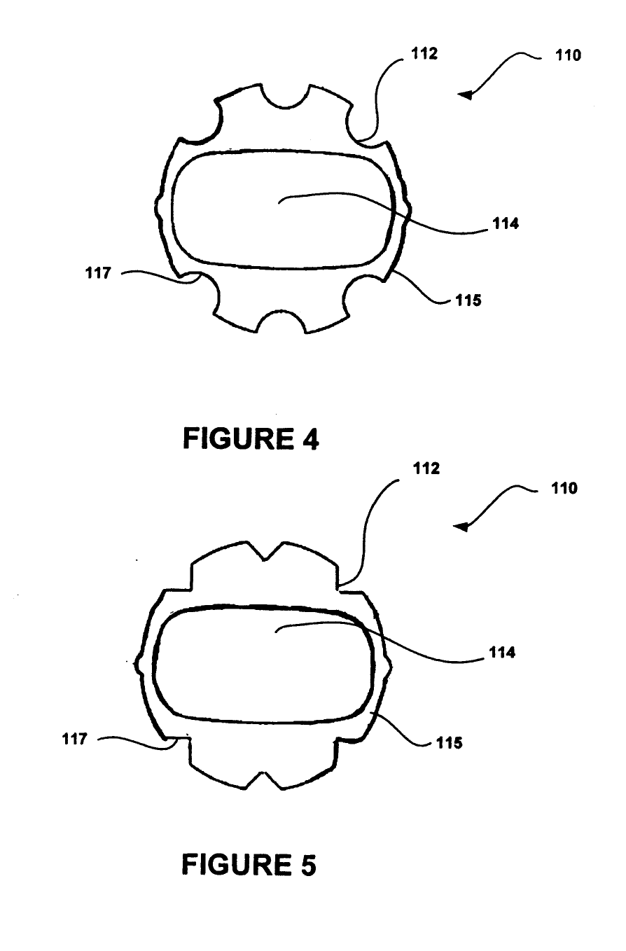

FIGS. 4-5 illustrate top views of various embodiment of the structure 110 with different shapes of the openings 112. As shown in FIG. 4, each opening 112 has a substantially U-shape and as shown in FIG. 5, each opening 112 has a substantially V-shape. The openings 112 may have a common shape, as depicted in FIGS. 4 and 5, or may be combinations of shapes. Other shapes may be used, and the V and U shape openings 112 depicted in FIGS. 4 and 5 are only exemplary. The location, number and/or size of the openings 112 affect the audio characteristics of the microphone 100. The use of openings 112 of the structure 110 affects the polar pattern of the microphone 100. Their use also affects the frequency response and sensitivity of the microphone 100.

It will be appreciated that numerous variations to the above-mentioned approaches are possible. Variations to the above approaches may, for example, include performing the above steps in a different order. Further, the openings 112 may be formed directly on the top housing portion 102 or the bottom portion 104 without introducing the structure 110. For example, the openings 112 may be formed on the side wall 150a or 150b (as shown in FIG. 1) of the housing portions 102 or 104 as long as sounds from all directions external to the housing portions 102, 104 enter through the openings 112 and interact with the motor assembly 116 via the back volume 128. Alternatively, the top housing portion 102, the bottom housing portion 104 or both housing portions 102, 104 may be molded with openings 112 as is done with previous example. In this case, the openings 112, interact with the back volume 128, may be formed radially around a circumference of the housing portions 102, 104 adjacent to the end wall 102a or 104a, so that similar time delay structure may be formed to provide the desired polar pattern of the microphone 100.

Preferred embodiments of this invention are described herein, including the best mode known to the inventors for carrying out the invention. It should be understood that the illustrated embodiments are exemplary only, and should not be taken as limiting the scope of the invention. It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

What is claimed:

1. A transducer comprising:
a housing having an inner space and a side wall;
a diaphragm assembly mounted within the housing dividing the inner space into a front volume and a back volume; and
a plurality of openings formed around the side wall of the housing, the plurality of openings communicating with the back volume.

2. The transducer of claim 1, further comprising a front port, the front port communicating with the front volume.

3. The transducer of claim 2, wherein the housing comprising a top housing portion and a bottom housing portion, the front port formed on the bottom housing portion.

4. The transducer of claim 3, wherein the openings being formed radially around a circumference of the top housing portion or the bottom housing portion, the openings communicating with the back volume.

5. The transducer of claim 4, further comprising a structure behind the diaphragm assembly, the structure disposed between the top housing portion and the bottom housing portion, and the openings formed on a peripheral edge of the structure.

6. The transducer of claim 5, wherein the structure has an aperture, the aperture receiving a circuit assembly.

7 The transducer of claim 6, wherein the structure comprises a disk-like, or plate-like structure.

8 The transducer of claim 5, wherein the openings have one of a U-shape or a V-shape.

9 The transducer of claim 5, wherein the housing has a one of a square, a rectangular or a circular cross-section and the structure has a corresponding shape.

10. The transducer of claim 1, wherein the transducer is adapted to receive acoustic energy and to provide an electrical output via at least one terminal pad.

11. The transducer of claim 1, wherein the transducer is adapted to receive an electrical input via at least one terminal pad and to provide a corresponding acoustic output.

12. The transducer of claim 1, wherein the transducer comprises one of a receiver, a speaker, a microphone, and combinations thereof.

13. The transducer of claim 1, wherein the transducer is mounted in an electronic device.

14. The transducer of claim, 14, wherein the electronic device comprises one of a headphone, a cellular phone, a camera, and a hearing aid.

15. The transducer of claim 1, wherein the openings communicating with the back volume are adapted to control at least one of a directivity characteristics of the transducer.

16. The transducer of claim, 15, wherein the directivity characteristics may be one of a polar response, frequency response, a sensitivity, or combination thereof.

17. A directional microphone comprising:
a housing having a top housing and a bottom housing, defining a chamber;
a diaphragm assembly mounted within the housing dividing the chamber into a front volume and a back volume;
a front port communicating with the front volume, the front port formed on the bottom housing; and
a structure having a plurality of openings attached between top and bottom housings, the plurality of openings communicating with the back volume;
wherein the openings are adapted to modify the directivity characteristics of the transducer.

18. The directional microphone of claim 17, wherein the directivity characteristics may be one of a polar response, frequency response, a sensitivity, or combination thereof.

19. The directional microphone of claim 17, wherein the structure comprises a disk-like, or plate-like structure.

20. The directional microphone of claim 17, wherein the openings have one of a U-shape or a V-shape.
